(19) United States
(12) Patent Application Publication
(10) Pub. No.: US 2017/0284509 A1
(43) Pub. Date: Oct. 5, 2017

(54) Shift Gear Wheel for High Gear Ratio Spread

(71) Applicant: Hilti Aktiengesellschaft, Schaan (LI)

(72) Inventors: Jochen Erhardt, Klosterlechfeld (DE); Thomas Reichenberger, Penzing (DE)

(73) Assignee: Hilti Aktiengesellschaft, Schaan (IL)

(21) Appl. No.: 15/507,625

(22) PCT Filed: Aug. 26, 2015
(86) PCT No.: PCT/EP2015/069511

§ 371 Date: Feb. 28, 2017

(30) Foreign Application Priority Data
Sep. 1, 2014 (EP) 14183016.6

(51) Int. Cl. F16H 3/083; F16H 15/52; F16H 55/17

(52) U.S. Cl. CPC F16H 3/083; F16H 55/17; F16H 15/52; F16H 2003/0807

(57) ABSTRACT

A gear wheel for a transmission, in particular a draw key transmission, is disclosed. The gear wheel contains a first ring element and a second ring element, the first ring element having a driving contour for receiving a shaft pin of the transmission and the second ring element having a toothing on an outer surface.

This application claims the priority of International Application No. PCT/EP2015/069511, filed Aug. 26, 2015, and European Patent Document No. 14183016.6, filed Sep. 1, 2014, the disclosures of which are expressly incorporated by reference herein.

### BACKGROUND AND SUMMARY OF THE INVENTION

The present invention relates to a gear wheel for a transmission, particularly a draw key transmission.

In a draw key transmission, similar to every other transmission, a rotational speed or a torque of a first shaft (input shaft) is transmitted to a second shaft (output shaft). To do so, on the first shaft as well as on the second shaft, there are a plurality of variably sized gear wheels, i.e., gear wheels with variably sized external diameters. The two shafts are arranged to each other in the transmission in such a manner that the individual gear wheels of the input shaft engage in the gear wheels of the output shaft. The individual gear wheels of the two shafts are thereby engaged with each other in various dimensional ratios. Depending on the configuration of the variably sized gear wheels of the input shaft and the output shaft to each other, various transmission ratios of the two shafts are possible in the transmission.

To do so, the individual gear wheels on the output shaft are positioned in a moveable manner, i.e., rotatable relative to the output shaft. In other words, there is no force-fit between the output shaft and the associated gear wheels. The output shaft can thus he rotated relative to the gear wheels.

In contrast, the gear wheels of the input shaft are rigidly (i.e., in a force-fitting manner) connected to the input shaft.

The output shaft is constructed as a hollow shaft, in which there is a draw key (also referred to as a shift pin). The draw key can be displaced by means of a shift rod in an axial direction within the output shaft designed as a hollow shaft.

The individual gear wheels of the output shaft have on the interior side a driving contour in the shape of opposing grooves. The draw key can be inserted into these grooves, by means of which a form- or force-fitting connection results between the output shaft and the respective gear wheel. Due to this form- and force-fitting connection between the output shaft and the respective gear wheel of the output shaft, the rotational speed or the torque of the input shaft can be transmitted via the corresponding gear wheels of both shafts to the output shaft.

For optimal usage or utilization of a draw key transmission, a largest possible gear ratio spread is highly significant. The gear ratio spread thereby refers to the dimensional ratio of the largest gear wheel (largest exterior diameter of the gear wheel) to the smallest gear wheel (smallest exterior gear wheel). However, due to the often limited installation space inside the transmission housing, the largest gear wheel cannot have an unrestrictedly large exterior diameter. The exterior diameter of the smallest gear wheel can in turn not fall below a minimum value, due to the necessary minimum diameter of the output shaft This minimum value is thereby frequently influenced by certain strength values and robustness prerequisites placed on this small gear wheel, since the smallest gear wheel in the transmission must also withstand and transmit relatively high rotational speeds as well as a relatively high torque. In other words, the exterior diameter of the smallest gear wheel is always considerably larger than the exterior diameter of the output shaft.

Therefore, the object of the present invention is to provide a gear wheel for a transmission, particularly a draw key transmission, with which the largest possible gear ratio spread can be achieved.

Being provided is a gear wheel for a transmission, particularly a draw key transmission.

According to the invention, the gear wheel comprises a first ring element and a second ring element, wherein the first ring element has a driving contour to accommodate a shift pin of the transmission and the second ring element has a toothing on its exterior surface.

By forming the gear wheel in the form of a first and second ring element, the dimensioning of the toothing of the gear wheel is uncoupled from the dimensioning of the drive contour for accommodating a shift pin of the transmission and variably configurable. The exterior diameter of the toothing can thereby be designed smaller than the exterior diameter of the driving contour, by means of which a smaller gear wheel and consequently a large gear ratio spread can be achieved.

According to an advantageous embodiment of the present invention, it may be provided that the second ring element is positioned in a direction behind the first ring element and the exterior diameter of the second ring element is smaller than the exterior diameter of the first ring element. This hereby ensures that the exterior diameter of the second ring element together with the toothing can be smaller than the exterior diameter of the first ring element together with the driving contour.

In addition, it may be advantageously provided that along a surface of the driving contour and along an interior surface of the second ring element, there is comprised a continuous running surface for an output shaft of the transmission. A continual contact of the interior surface of the gear wheel on the surface of the output shaft is thereby ensured, by means of which a continuous running of the gear wheel about the output shaft, i.e., without a skipping of the gear wheel off the output shaft, is achieved.

Furthermore, it may be provided that the driving contour comprises at least four opposing grooves on the interior surface of the first ring element. Rapid admission of the shift pin in the grooves of the driving contour and thus a rapid switchover to another gear wheel can be ensured.

Additional advantages emerge from the following descriptions of the drawings. The drawings depict various embodiments of the present invention. The drawings, the description, and the claims contain numerous features in combination. A person skilled in the art will also consider the features individually when suitable and bring them together in other reasonable combinations.

### BRIEF DESCRIPTION OF THE DRAWINGS

FIG. 1 depicts a perspective view of an output shaft with a number of gear wheels and a shift rod together with a gear wheel according to the invention;

FIG. 2 depicts a cross-section through the output shaft along with the gear wheels, shift rod, and draw key;

FIG. 3 depicts a cross-section through the gear wheel, draw key, and shift rod;

FIG. 4 depicts a cross-section through the gear wheels and draw key;

FIG. 5 depicts a cross-section through the gear wheels;

FIG. 6 depicts a perspective view of the gear wheel according to the invention and a draw key;

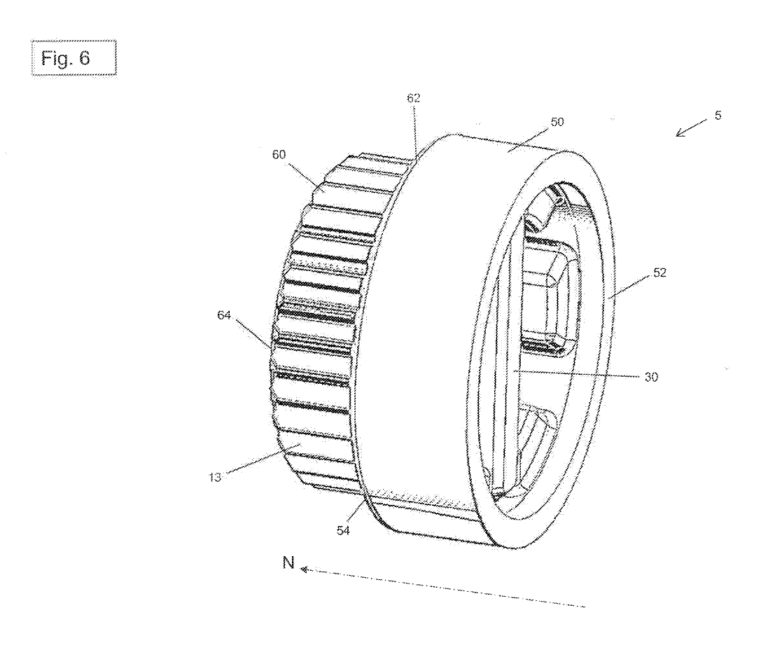

FIG. 7 depicts a side view of the gear wheel according to the invention;

FIG. 8 depicts a cross-section through the gear wheel according to the invention;

FIG. 9 depicts a cross-section through the gear wheel according to the invention and draw key;

FIG. 10 depicts a perspective rear view of the gear wheel according to the invention; and

FIG. 11 depicts a perspective front view of the gear wheel according to the invention.

### DETAILED DESCRIPTION OF THE DRAWINGS

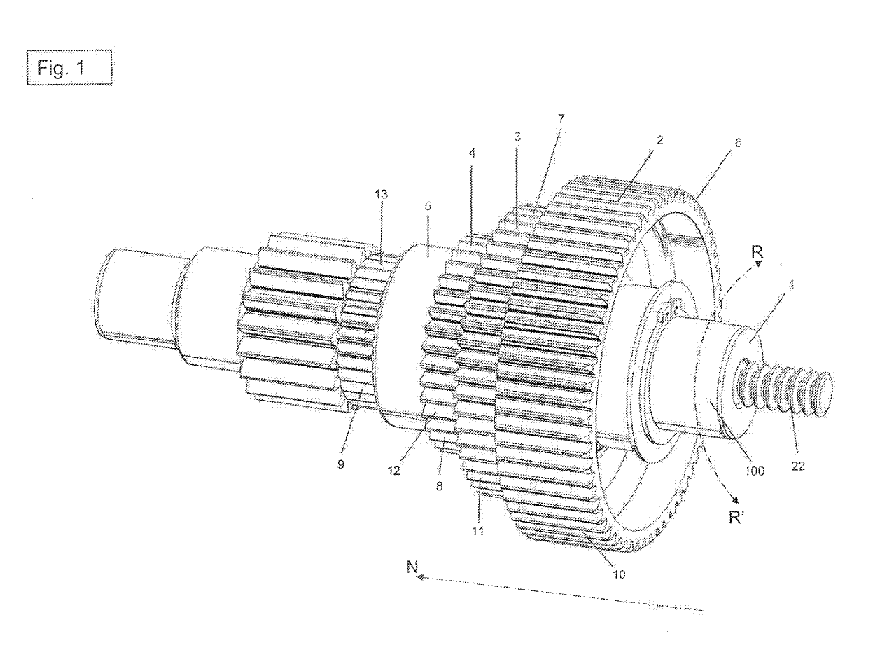

FIG. 1 depicts an output shaft 1 with a first gear wheel 2, second gear wheel 3, third gear wheel 4, and fourth gear wheel 5. Each of the gear wheels 2, 3, 4, 5 has a corresponding toothing 10, 11, 12, 13 on the respective exterior surface 6, 7, 8, 9.

The four gear wheels 2, 3, 4, 5 have variously sized exterior diameters. First gear wheel 2 has the largest exterior diameter, second gear wheel 3 has the second largest exterior diameter, third gear wheel 4 has the third-largest exterior diameter; and fourth gear wheel 5 has the fourth-largest and thus smallest exterior diameter. Output shaft 1 as well as the four gear wheels 2, 3, 4, 5 are part of a (not depicted) draw key transmission. Belonging to the draw key transmission is also an input shaft, on which a first gear wheel, a second gear wheel, a third gear wheel, and a fourth gear wheel are also positioned. The four gear wheels of the input shaft also have variably sized exterior diameters. The input shaft as well as the first gear wheel, second gear wheel, third gear wheel, and fourth gear wheel on the input shaft are not depicted in the drawings. The four gear wheels 2, 3, 4, 5 of output shaft 1 as well as of the input shaft are positioned to each other in a reciprocal size ratio such that the toothing of the gear wheels mesh. Output shaft 1 and the input shaft are positioned parallel to each other in the transmission. Toothing 10 of gear wheel 2 of the output shaft having the largest exterior diameter meshes with the toothing of the gear wheel of the input shaft having the smallest diameter. As is typical in a draw key transmission, the remaining gear wheels 3, 4, 5 of output shaft 1 and the input shaft are positioned to each other corresponding to their exterior diameters. By means of the size-differentiated arrangement of the gear wheels with various exterior diameters, various gear ratios can be achieved by the rotational speed or torque between the input shaft and output shaft 1.

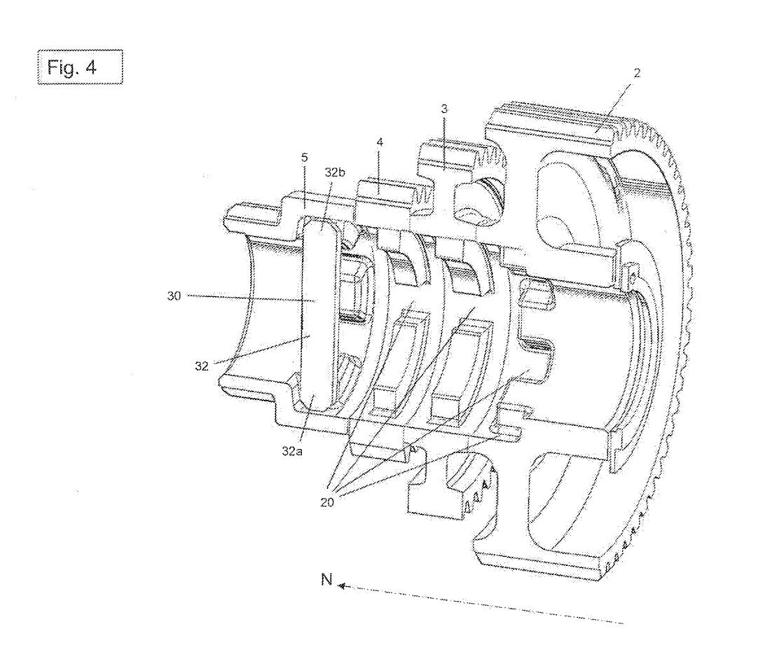

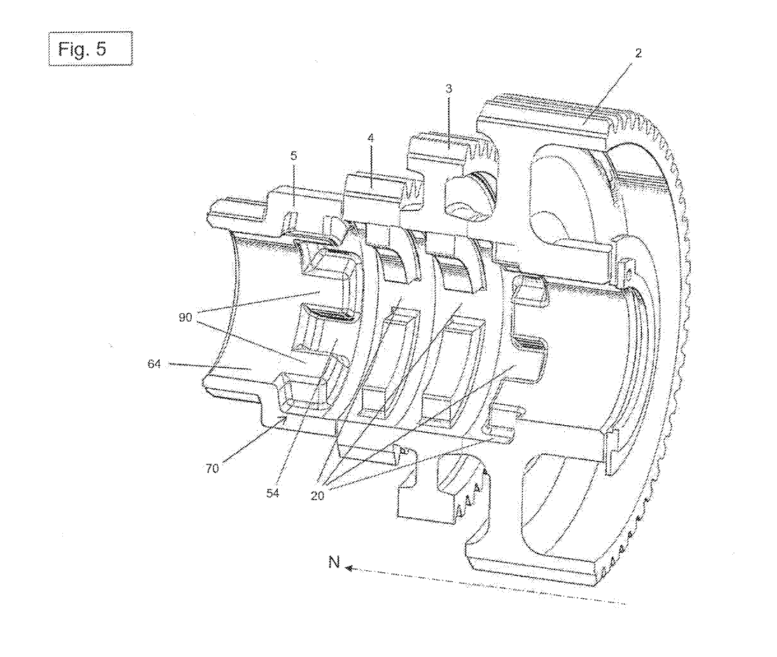

As shown in FIGS. 1 to 5, the four gear wheels 2, 3, 4, 5 of output shaft 1 are rotatably positioned in an axial direction N In succession on output shaft 1. The four gear wheels 2, 3, 4, 5 can thus be rotated relative to output; shaft 1 in direction of rotation R or R′ (see FIG. 1). As shown particularly in FIG. 5, each of the four gear wheels 2, 3, 4, 5 comprises at the respective exterior surface 6, 7, 8, 9 a corresponding toothing 10, 11, 12, 13 and on the interior surface a number of opposing grooves 20. As described hereafter in detail, grooves 20 serve to hold a draw key 30.

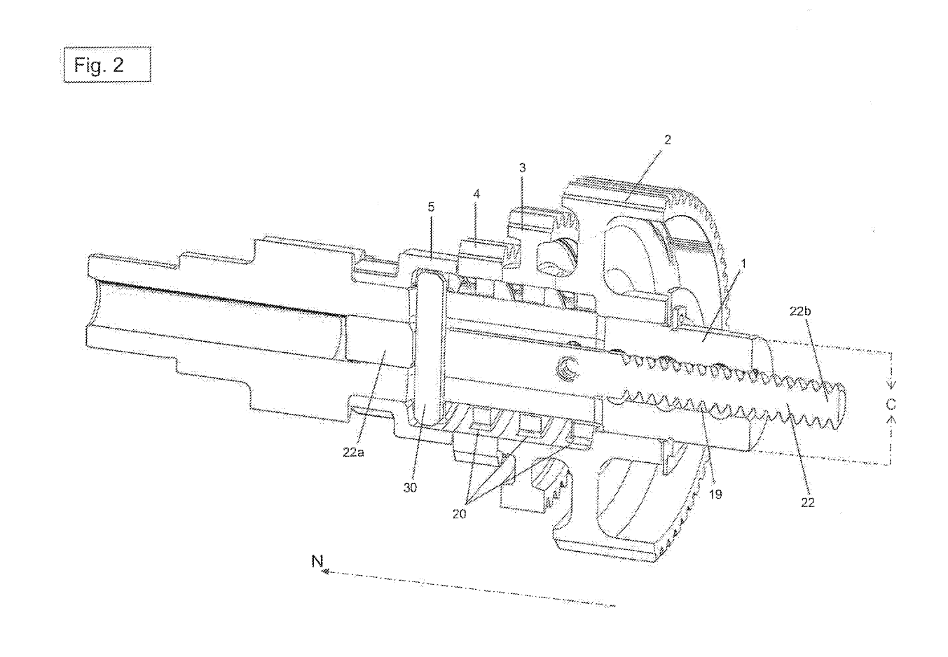

As depicted particularly in FIG. 2, output shaft 1 has a through-hole 19. Positioned in through-hole 19 is a shift rod 22. Shift rod 22 can be displaced in and against axial direction N relative to output shaft 1.

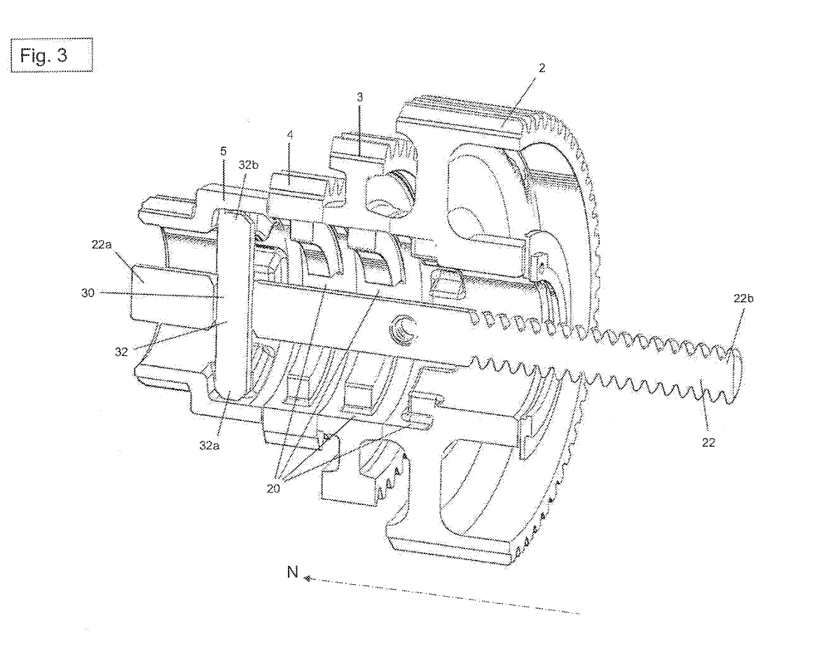

As shown in FIG. 3, shift rod 22 has a first end 22a and a second end 22b. Draw key 30 (also referred to as shift pin) is attached in the vicinity of first end 22a of shift rod 22. Draw key 30 comprises a cylindrical main body 32 with a first end 32a and a second end 32b. Main body 32 of draw key 30 is arranged perpendicular to the longitudinal extension of output shaft 1 and axial direction N. First end 32a and second end 32b of main body 32 project out of output shaft 1.

By means of shift rod 22, draw key 30 can be moved both opposite to axial direction N along output shaft 1 and relative to the four gear wheels 2, 3, 4, 5. Draw key 30 is thereby dimensioned in such a manner that first end 32a and second end 32b of main body 32 can be inserted in respective grooves 20 of the individual four gear wheels 2, 3, 4, 5. When draw key 30 is inserted in respective grooves 20 of one of the four gear wheels 2, 3, 4, 5, there exists a force-fitting connection between output shaft 1, draw key 30, and respective gear wheel 2, 3, 4, 5. Shifting the position of draw key 30 from a force-fitting connection with a gear wheel (e.g., second gear wheel 3) to a force-fitting connection with another gear wheel (e.g., third gear wheel 4) causes a gear change and consequently a change of the gear ratio within the draw key transmission. In FIGS. 2 to 4, draw key 30 is inserted in two of the six grooves 41, 42, 43, 44, 45, 46 of fourth gear wheel 5.

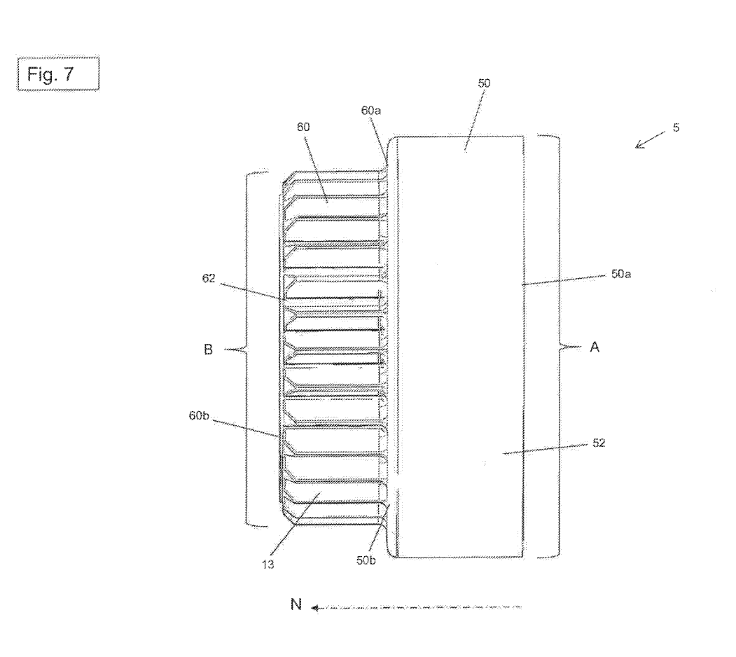

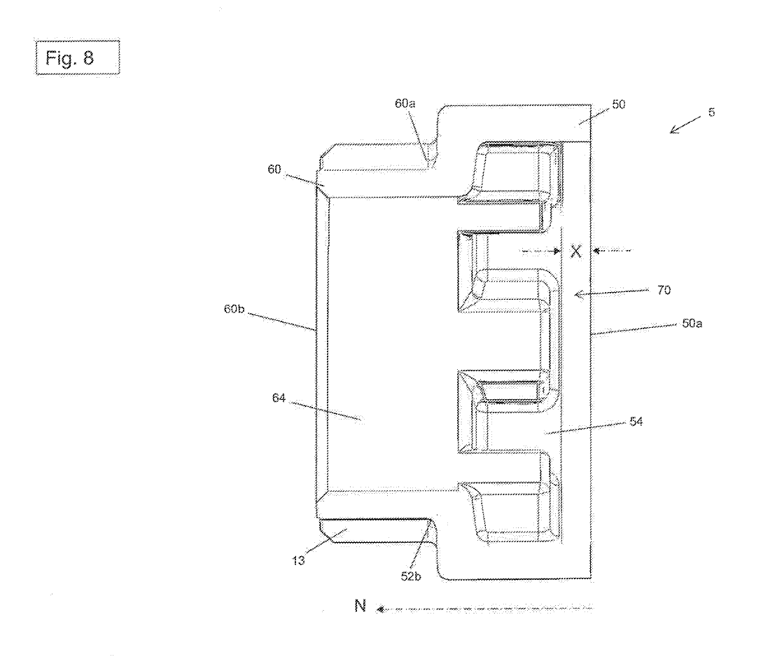

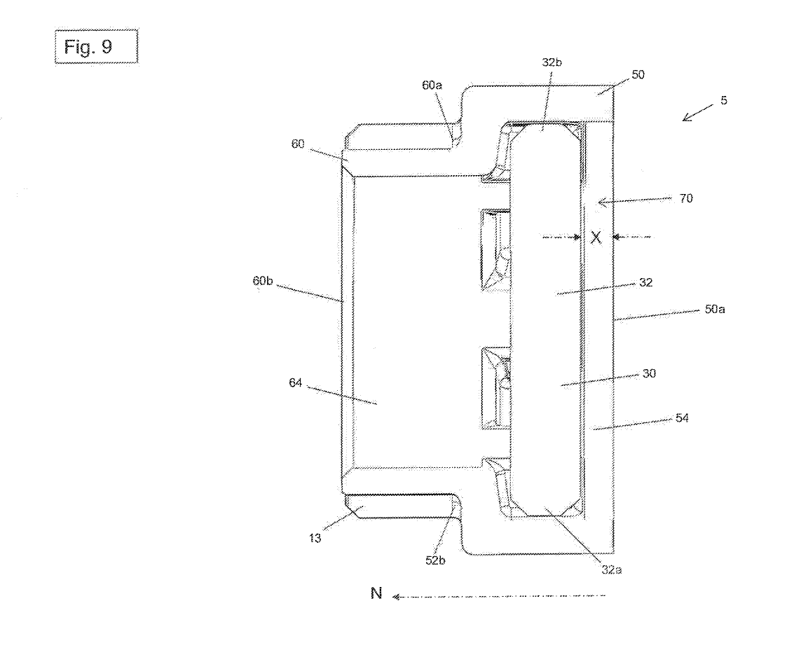

As depicted in FIGS. 7 to 11, fourth gear wheel 5 comprises a first ring element 50 and a second ring element 60.

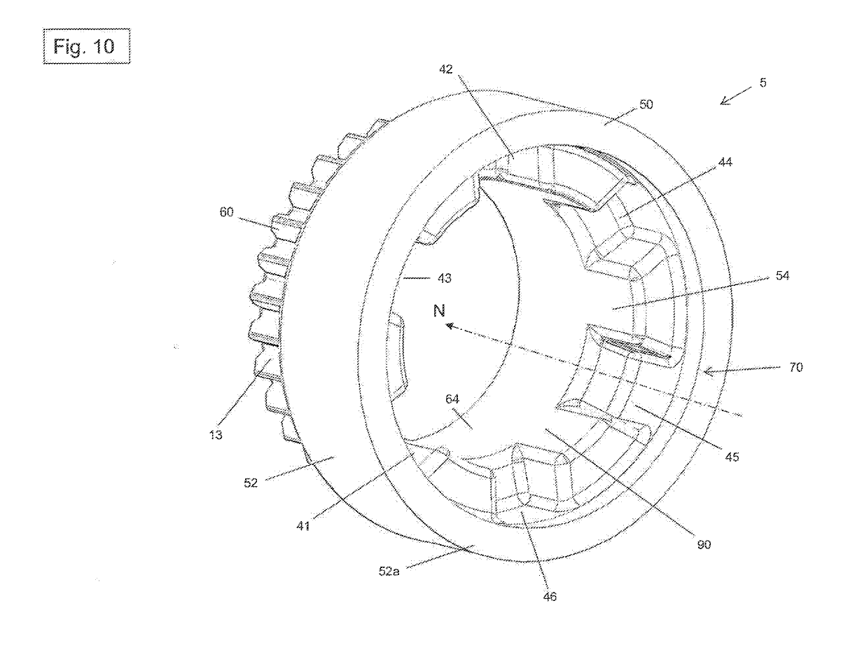

First ring element 50 comprises a first end 50a, a second end 50b, an exterior surface 52, and an interior surface 54 (see FIG. 10). Exterior surface 52 of first ring element 50 is designed as a continuous surface. Interior surface 54 of first ring element 50 comprises a driving contour 70. Driving contour 70 comprises six grooves 41, 42, 43, 44, 45, 46, which are broken down into three pairs of grooves, each with two opposing grooves. The six grooves 41, 42, 43, 44, 45, 46 are positioned in a manner such that they are spaced at even intervals to each other on interior surface 54 of first ring element 50. Extending along grooves 41, 42, 43, 44, 45, 46 and about driving contour 70, there is interior surface 54, which is designed as a smooth continuous surface. According to an alternative (not depicted) embodiment of the present invention, driving contour 70 may have less or more than six grooves or three pairs of grooves. The pairs of grooves serve to accommodate first end 32a and second end 32b of main body 32 of draw key 30. Driving contour 70 is positioned at a certain distance X from first end 50a of first ring element 50. Distance X of driving contour 70 to first end 50a of first ring element 50 serves to insert draw key 30 more easily into driving contour 70 during a gear change.

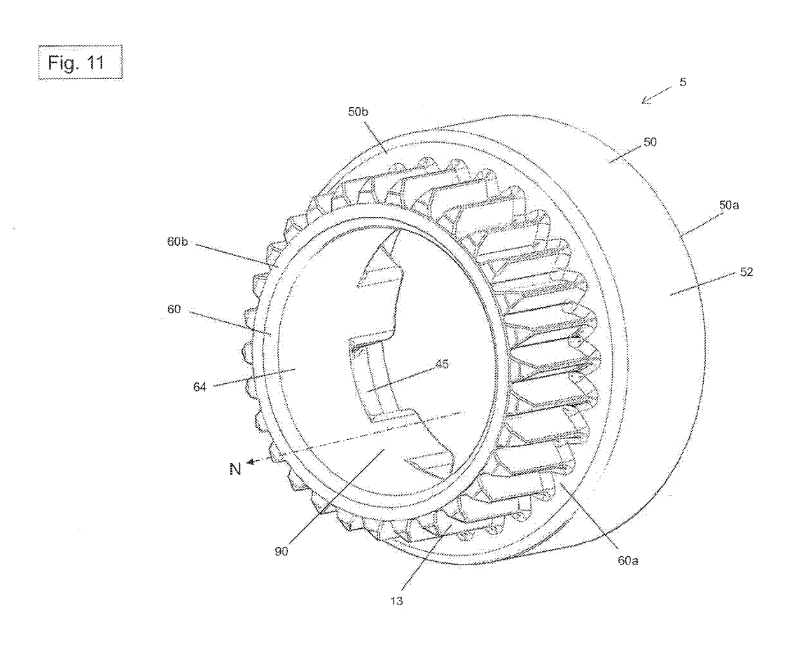

Second ring element 60 comprises a first end 60a, a second end 60b, an exterior surface 62, and an interior surface 64. As depicted particularly in FIG. 11, peripheral toothing 13 is positioned on exterior surface 62 of second ring element 60. Interior surface 64 of second ring element 60 is designed as a smooth continuous surface.

First ring element 50 and second ring element 60 are positioned successively in axial direction N so that second end 54 of first ring element 50 abuts first end 62 of second ring element 60. In addition, exterior diameter A of first ring element 50 is greater than exterior diameter B of second ring element 60. As shown in FIG. 7, exterior diameter B of second ring element 60 together with toothing 13 is smaller than exterior diameter A of first ring element 50. In particular, exterior diameter B of second ring element 60 together with toothing 13 is only slightly larger than exterior diameter C of output shaft 1 (see FIG. 2).

Surface 90 about driving contour 70 and interior surface 64 of second ring element 60 form a smooth continuous contact surface, so that surface 100 of output shaft 1 is, over a large surface area, in contact with surface 90 about driving contour 70 and interior surface 64 of second ring element 60. By means of this contact over a large surface area, a particularly steady revolution, i.e., without skipping or fretting, of fourth gear wheel 5 about output shaft 1 is ensured.

The toothing as well as the driving contour of the gear wheel according to the invention may he manufactured by cold extrusion. However, it is also possible that the gear wheel according to the invention is also produced with other suitable manufacturing processes.

1.-4. (canceled)

5. A gear wheel for a transmission, comprising:
a first ring element; and
a second ring element, wherein the second ring element abuts the first ring element;
wherein the first ring element has a driving contour for accommodating a shift pin of the transmission and wherein the second ring element has a toothing on an exterior surface of the second ring element.

6. The gear wheel according to claim 5, wherein the second ring element is positioned in a direction behind the first ring element and wherein an exterior diameter of the second ring element is smaller than an exterior diameter of the first ring element.

7. The gear wheel according to claim 5, wherein a continuous contact surface for an output shaft of the transmission is formed along a surface of the driving contour and along an interior surface of the second ring element.

8. The gear wheel according to claim 5, wherein the driving contour includes at least four opposing grooves on an interior surface of the first ring element.
